(19) United States
(12) Patent Application Publication
(10) Pub. No.: US 2015/0186831 A1
(43) Pub. Date: Jul. 2, 2015

(54) Systems and Methods for Managing Check-in Communications

(71) Applicant: MASTERCARD INTERNATIONAL INCORPORATED, Purchase, NY (US)

(72) Inventors: Daniel Hulbert, Troy, MO (US); Ryan D. Preston, Lake St. Louis, MO (US)

(73) Assignee: MASTERCARD INTERNATIONAL INCORPORATED, Purchase, NY (US)

(21) Appl. No.: 14/174,924

(22) Filed: Feb. 7, 2014

Related U.S. Application Data
(60) Provisional application No. 61/922,325, filed on Dec. 31, 2013.

(51) Int. Cl. G06Q 10/06; H04W 4/22; G06Q 50/26; H04L 12/58

(52) U.S. Cl. CPC G06Q 10/063114; H04L 51/04; H04W 4/22; G06Q 50/265

(57) ABSTRACT

Systems, methods and devices for use in managing check-in communications are disclosed. One exemplary method generally includes receiving a notification request associated with a trigger event, where the notification request is indicative of multiple participants associated with the trigger event, and identifying the multiple participants. The method also generally includes, for each of the identified participants, sending a check-in communication to the participant and generating a warning event when the check-in communication is acknowledged by the participant and the acknowledgment includes a negative condition.

### CROSS-REFERENCE TO RELATED APPLICATIONS

This application claims the benefit of U.S. Provisional Application No. 61/922,325, filed on Dec. 31, 2013. The entire disclosure of the above application is incorporated herein by reference.

### FIELD

The present disclosure generally relates to systems and methods for managing check-in communications.

### BACKGROUND

This section provides background information related to the present disclosure which is not necessarily prior art.

Domestic and international business activity is important to many companies. Travel within this or different countries is often necessary to promote the business activity. However, as can be appreciated, numerous risks are associated with such travel, such as risks associated with simply flying to the different countries and risks associated with traveler presence in the different countries. Furthermore, emergency events may occur at different locations around the world, which may place persons at those locations in dangerous or uncertain situations. In some instances it can be difficult to confirm the safety of those persons during or after such events.

### DRAWINGS

The drawings described herein are for illustrative purposes only of selected embodiments and not all possible implementations, and are not intended to limit the scope of the present disclosure.

FIG. 1 shows an exemplary system for use in managing check-in communications;

FIG. 2 is a block diagram of an exemplary computing device, suitable for use in the system of FIG. 1;

FIG. 3 is a flowchart of an exemplary method for managing check-in communications to account for traveler safety during travel, which can be implemented via the system of FIG. 1;

FIGS. 4A-4C are portions of an exemplary travel request page for use in the method of FIG. 3;

FIG. 5 is an exemplary status page for use in viewing pending check-in communications for multiple travelers in the method of FIG. 3;

FIG. 6 is the exemplary status page of FIG. 5, with a warning event set for one of the travelers resulting from a missed check-in communication;

FIG. 7 is a flowchart of an exemplary method for managing check-in communications in response to a trigger event, which can be implemented via the system of FIG. 1; and

FIG. 8 is an exemplary notification request page for use in managing the check-in communications.

Corresponding reference numerals indicate corresponding parts throughout the several views of the drawings.

### DETAILED DESCRIPTION

Disclosed herein are systems and methods for managing check-in communications. In some aspects, the systems and methods may be used, for example, in managing travel to account for the safety of participants during travel. In other aspects, the systems and methods may be used, for example, to account for the safety of participants in response to certain trigger events (e.g., emergencies, pandemics, dangerous events, security incidents, etc.). In such aspects, and in other additional aspects of the present disclosure, participants may be able to acknowledge a check-in communication, thereby permitting an organizer (e.g., an employer, etc.) to confirm the participants' status and, if necessary, take additional action.

In numerous embodiments, certain risks are involved in travel, including travel in foreign countries, and especially travel in countries with unstable governments, countries involved in conflicts, and/or countries in which certain travelers are targeted by criminals or terrorists. The check-in management systems and methods herein may permit an organizer to account for participants during travel (e.g., segments of travel, and particularly high-risk travel segments of such travel, etc.). For example, check-in communications may be provided to confirm the status of participants at different predetermined check-in times during their travel. In response, a participant may be required to acknowledge the check-in communications, through a portable communication device, within a certain time interval, thereby permitting the organizer, such as an employer, to account for the status of the participants.

In various embodiments, events often occur at one or more locations around the world that place participants in those locations in dangerous or uncertain conditions. It can be difficult to account for the safety of participants during such events, i.e., trigger events. The check-in management systems and methods herein may permit an organizer to account for the status of the participants during or after trigger events. For example, check-in communications may be sent during or following a trigger event to participants potentially affected by the trigger event. The participants may include travelers in a location of the event and/or resident employees of the location, etc. In response, the participants can acknowledge the check-in communications, through a portable communication device, to indicate their condition and/or safety. As such, an organizer can account for the status of the participants in response to the trigger event.

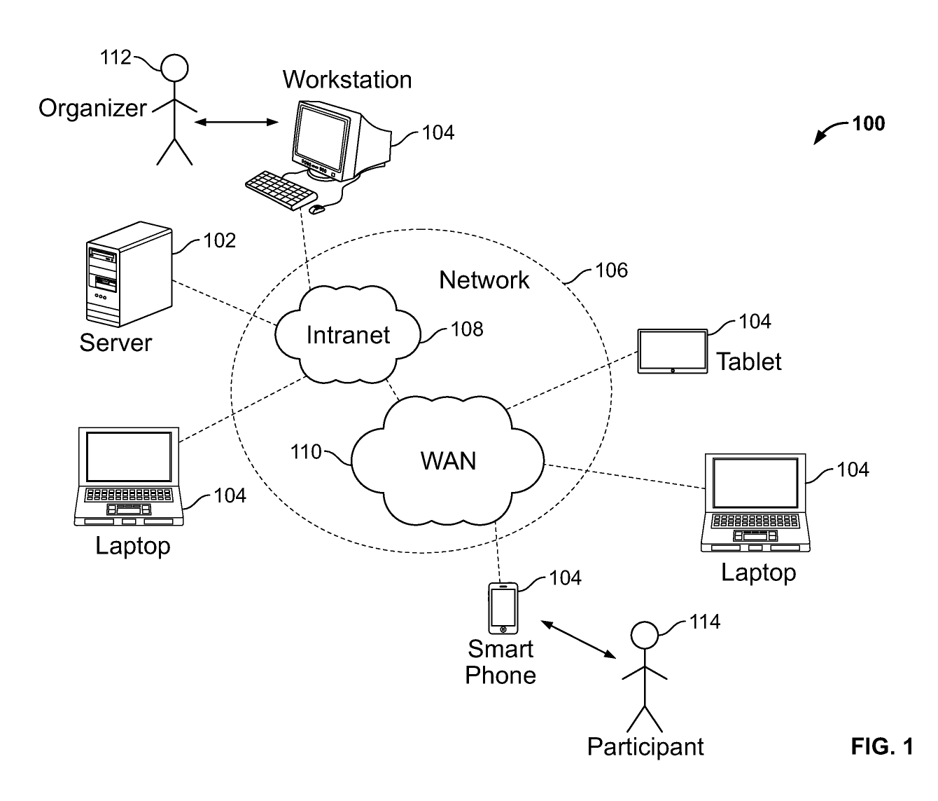

With reference now to the drawings, FIG. 1 illustrates an exemplary system 100 for use in managing check-in communications, and in which one or more aspects described herein may be implemented. It should be appreciated that although in the illustrated embodiment, elements of the system 100 are presented in one arrangement, other embodiments may include the same or different elements arranged otherwise, for example, depending on an organizer of the check-in communications, trigger events, travel destinations, number of participants, and/or check-in requirements, etc.

As shown in FIG. 1, the system 100 includes a server 102 and multiple communication devices, each indicated at reference number 104, and each coupled to the server 102, via a network 106. The system 100 may be accessed and/or utilized by at least two different types of participants: organizers 112 and participants 114, for example. Participants 114 include, without limitation, travelers, employees, or other persons associated with the organizer 112 or to whom the organizer 112 may be responsible in some way, and dispersed in one or more locations throughout the world. Conversely, the organizers 112 may include employers, third parties, government agencies, or other entities, which have an interest in the status and/or safety of participants 114. In the system 100, an organizer 112 utilizes the server 102, either directly or indirectly through a computing device 104, such as, for example, a workstation, to interface the check-in management systems and methods described herein. The participants 114, who are often in transit or at different locations from the organizer 112, utilize communication devices 104, such as, for example, portable communication devices, to interface the check-in management systems and methods described herein. In at least one embodiment, however, an organizer may utilize a portable communication device, and a participant may utilize the server 102, directly or through the communication device 104.

One or more of the communication devices 104 may include, without limitation, a tablet computer (e.g., an iPad™, a Samsung Galaxy™, etc.), a desktop computer, a laptop computer, a workstation computer, a personal computer, a handheld computer or a communication device (e.g., a netbook, a specialized reservation device, etc.), a smart phone (e.g., an iPhone™, a BlackBerry™, a HTC™ phone, etc.), a pager, the like, or combinations thereof. Similarly, any suitable server, as known to those skilled in the art, may be employed. In addition, the network 106 may include, without limitation, a local private intranet, a local area network (LAN), a wide area private network, a wide area public network (e.g., the Internet, etc.), a mobile network, a virtual network, and/or another suitable network capable of supporting communication between the server 102 and one or more of the communication devices 104, and combinations thereof. The network 106 includes, in this particular embodiment, a wide area public network (WAN) 110 (such as, the Internet, etc.), and a private intranet 108 accessible to, for example, the organizer 112 or participant 114 to initiate events, send and/or acknowledge check-in communications and/or submit or manage existing travel requests and/or travel plans.

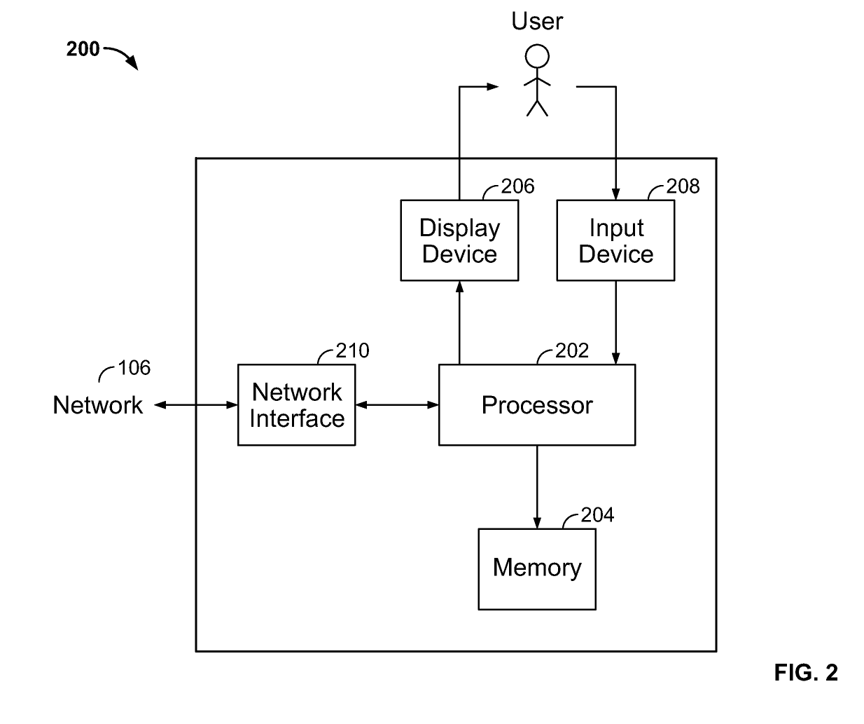

FIG. 2 illustrates an exemplary computing device 200. In the exemplary embodiment of FIG. 1, each of the server 102 and the communication devices 104 is a computing device, consistent with computing device 200. The system 100, and its components, however, should not be considered to be limited to the computing device 200, as different computing devices and/or arrangements of computing devices may be used. In various embodiments, the server 102, for example, includes multiple computing devices located in close proximity, or distributed over a geographic region.

Referring again to FIG. 2, the exemplary computing device 200 includes a memory 204 and a processor 202 that is coupled to memory 204. Processor 202 may include one or more processing units (e.g., in a multi-core configuration, etc.). Computing device 200 is programmable to perform one or more operations described herein by programming memory 204 and/or processor 202. Processor 202 may include, but is not limited to, a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and thus are not intended to limit in any way the definition and/or meaning of processor.

Memory 204, as described herein, is one or more devices that enable information, such as executable instructions and/or other data, to be stored and retrieved. Memory 204 may include one or more computer-readable media, such as, without limitation, dynamic random access memory (DRAM), static random access memory (SRAM), a solid state disk, and/or a hard disk. Memory 204 may be configured to store, without limitation, participant profiles, default check-in schedules, notification and/or travel requests, traveler profiles, travel plans, historical travel information, default notification messages and/or conditions, and/or any other type of data suitable for use as described herein.

In the exemplary embodiment, computing device 200 includes a display device 206 that is coupled to processor 202. Display device 206 outputs to a user by, for example, displaying and/or otherwise outputting information such as, but not limited to, pages, counts, tabulations, interfaces, warnings, events, alerts, check-in status, traveler profiles, travel plans, and/or any other type of data. Display device 206 may include, without limitation, a cathode ray tube (CRT), a liquid crystal display (LCD), a light-emitting diode (LED) display, an organic LED (OLED) display, and/or an “electronic ink” display. In some embodiments, display device 206 includes multiple devices.

In the exemplary embodiment, computing device 200 further includes an input device 208 that receives input from a user, such as the organizer 112 or the participant(s) 114. For example, input device 208 may be configured to receive inputs, acknowledgements, selections, and/or any other type of inputs from the user. In the exemplary embodiment, input device 208 is coupled to processor 202 and may include, for example, a keyboard, a pointing device, a mouse, a stylus, a touch sensitive panel (e.g., a touch pad or a touch screen, etc.), and/or an audio input device. Further, in various exemplary embodiments, a touch screen, such as that included in a tablet or similar device, functions as both display device 206 and input device 208. In at least one embodiment, the input device 208 includes a GPS receiver, configured to receive and/or process signals from one or more GPS satellites to determine a location of the computing device 200.

In the exemplary embodiment, computing device 200 also includes one or more network interface devices 210 coupled to processor 202. Network interface device 210 may include, without limitation, a wired network adapter, a wireless network adapter, a mobile telecommunications adapter, or other device capable of communicating to one or more different networks, including the network 106. In at least one embodiment, computing device 200 includes processor 202 and one or more network interface devices 210 incorporated into or with processor 202.

In further embodiments, computer-executable instructions are stored on non-transitory memory 204 for execution by processor 202 to perform one or more of the functions described herein. These instructions may be embodied in a variety of different physical or tangible computer-readable media, such as memory 204 or other non-transitory memory, such as, without limitation, a flash drive, CD-ROM, thumb drive, floppy disk, etc. Computer-readable media may be selectively insertable to and/or removable from a computing device to permit access to and/or execution by processor 202. In one example, computer-readable media includes a separate optical or magnetic disc that is inserted or placed into an input device 208 associated with memory 204 and/or processor 202. In some instances, the computer-readable media may not be insertable/removable.

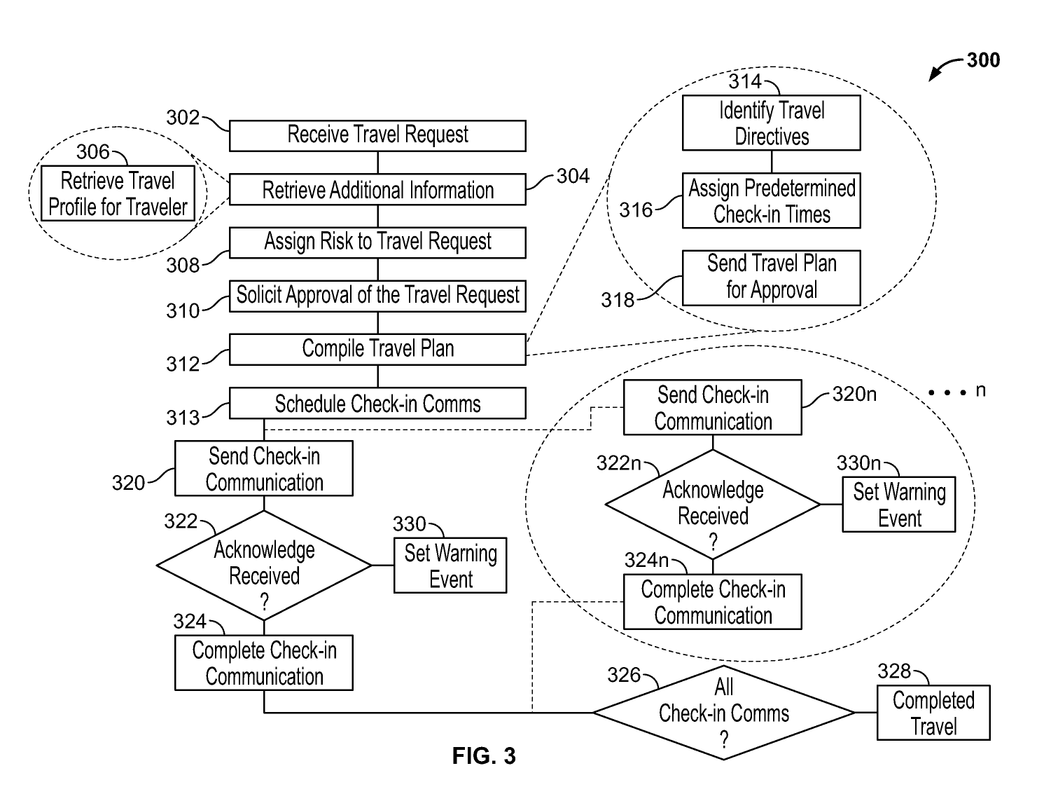

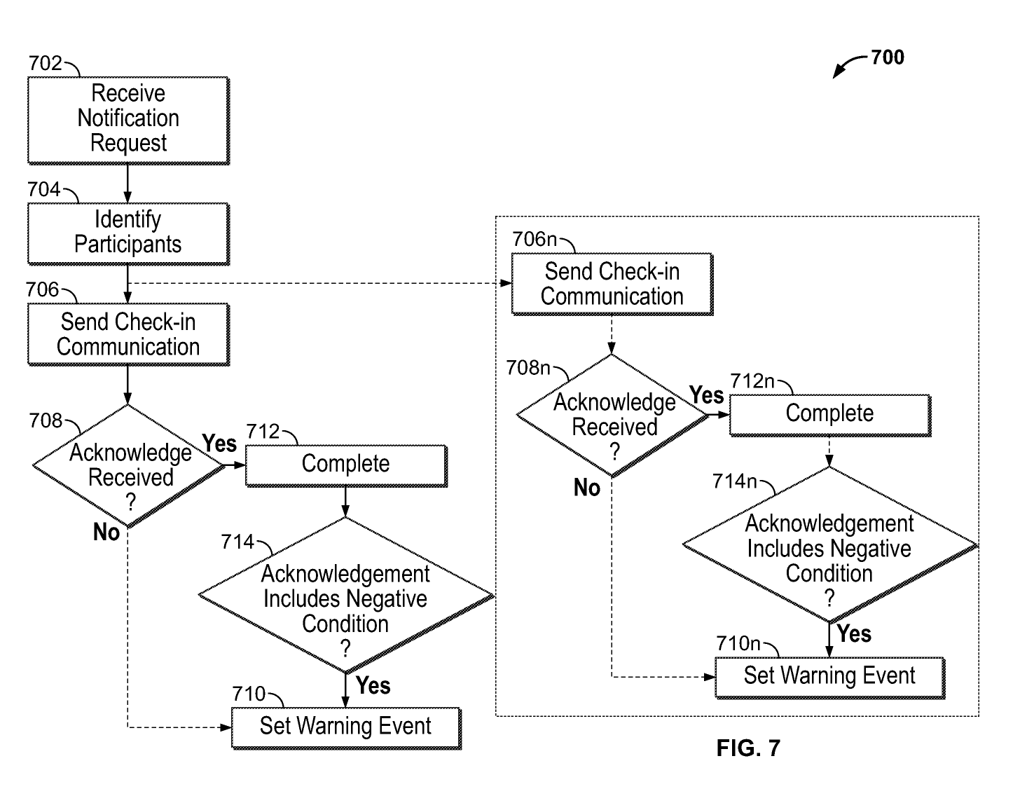

In the exemplary embodiment, the server 102 is configured to, among other things, receive notification requests and/or travel requests, compile travel plans, send check-in communications, track/monitor acknowledgements of the check-in communications, set warning events under certain conditions, send reminder communications, etc. Specific configurations of the exemplary server 102 and/or communication devices 104 are further described below with reference to the exemplary methods 300 and 700 of FIGS. 3 and 7, respectively. It should be appreciated, however, that the methods (e.g., methods 300, 700, etc.) described herein are not limited to the exemplary system 100, or the computing device 200, but may be implemented in a variety of different systems and/or computing devices. Likewise, systems (e.g., system 100) and computing devices (e.g., computing device 200) described herein should not be understood to be limited to the exemplary methods of the present disclosure (e.g., the methods 300 and 700 of FIGS. 3 and 7, respectively).

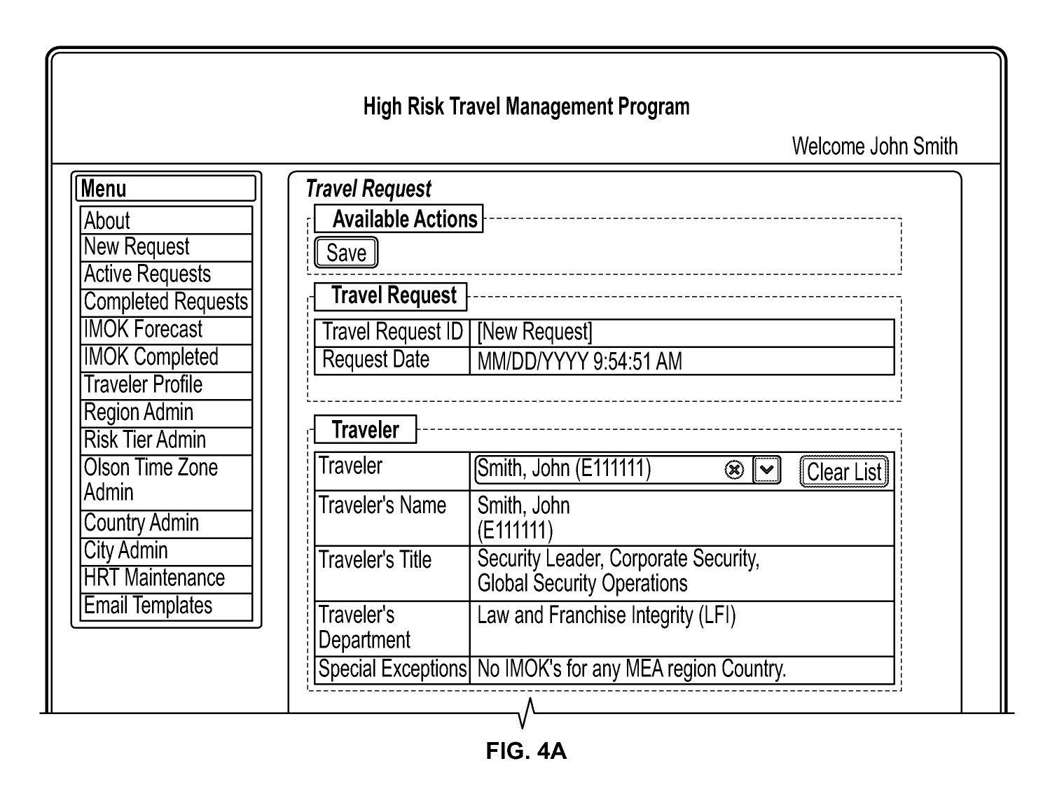

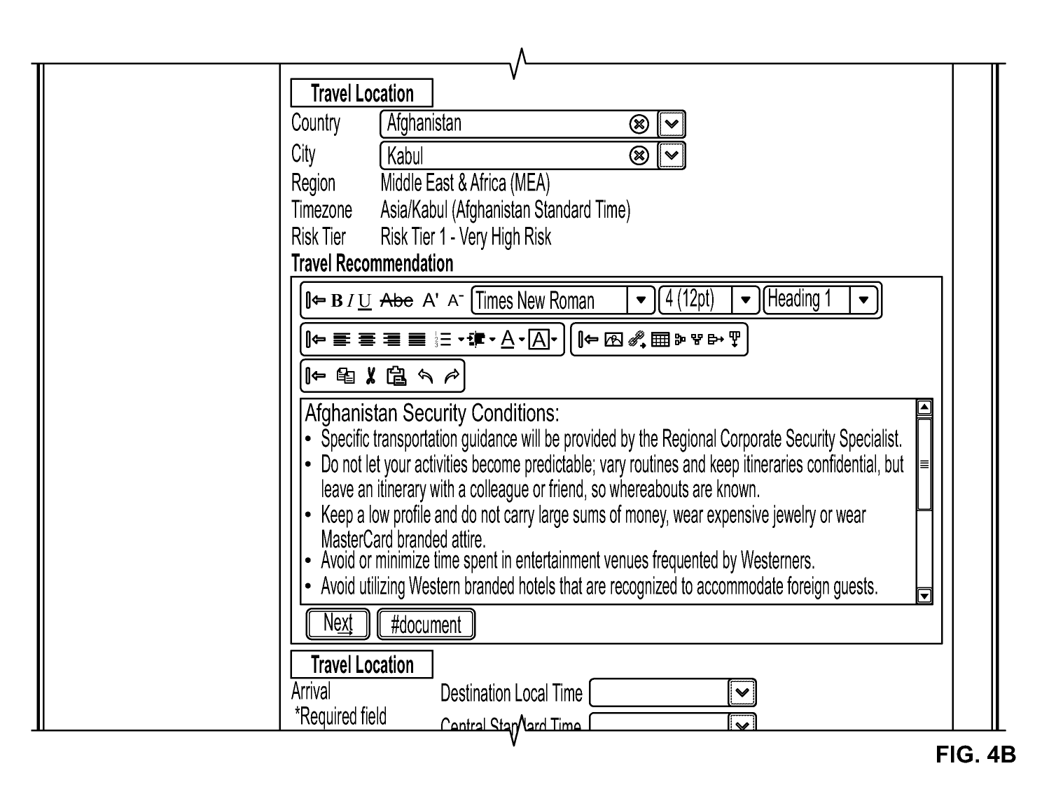

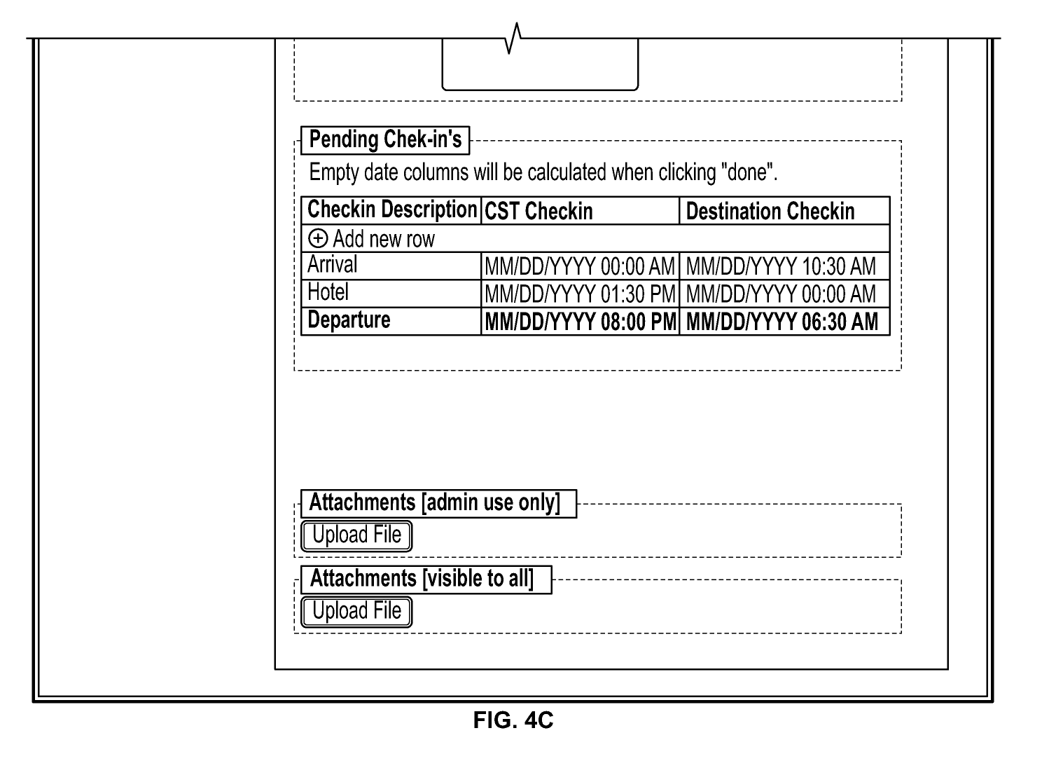

Additionally, exemplary pages are illustrated in FIGS. 4-6 and 8 as further description of the methods and systems herein. The exemplary pages are webpages, which are transmitted from the server 102 to a communication device 104, in one or more forms, including as packetized data, etc., and displayed to a user, via one or more of the communication devices 104 at display device 206. Additionally, the pages displayed at one or more of the communication devices 104 may solicit information and/or an acknowledgement from the user, which may be entered via input device 208.

With reference now to the method 300 of FIG. 3, when a trip to a particular destination is desired, a participant 114 (referred to hereinafter as a traveler for method 300) prepares a travel request for submission to the system 100. The travel request may be a travel request form completed by the traveler, for example, through a communication device 104, via intranet 108, or may be in a different format, such as paper form or email. When the travel request is a form, such as shown in the exemplary page of FIGS. 4A-4C, certain information may be required in order to submit the form, while other information is not required. The required travel information, in some embodiments, may be based on the travel destination. In particular, more travel information may be required to travel to the Middle East or South America, for example, as compared to Europe or Canada. The destinations may be foreign or domestic, and may include countries with a variety of risk levels, as further described below. The travelers may be person(s) or group(s) of persons who travel to the one or more destinations.

The travel request may include travel information, such as the traveler's name, the travel country, the travel city, and the dates of travel, as shown, for example, in FIGS. 4A-4C. In this example embodiment, drop-down menus in the travel request indicate fields to be completed by the traveler (and may include predefined selection options for each field, where additional options may only be available upon request to the organizer of the travel). Other fields in the travel request may also be shown to the traveler, but may not be editable by the traveler (e.g., the traveler's title with the company, etc.). Such other fields may only be editable by an organizer. Further, the fields available for edit to the traveler may change during the submission and/or approval process of the travel request (e.g., the travel destination may only be editable to the traveler when creating the travel request, and may then be un-editable to the traveler during subsequent approval steps, or different fields may become editable based on information entered in other fields, etc.). In other exemplary embodiments, travel requests may include additional and/or different fields to solicit, from the traveler, information, such as travel itinerary fields, traveler notes for consideration in reviewing the travel requests, medical conditions, status fields, etc. It should be appreciated that the fields and/or arrangements of the fields may be different than illustrated in the exemplary page of FIGS. 4A-4C. In at least one embodiment, the traveler is permitted to electronically attach information, such as, for example, travel arrangements and/or schedules, travel confirmations, reservations, etc., to the travel request.

Once the travel request is prepared, it is transmitted to and/or received 302 by the server 102, for example, from one of the communication devices 104 or another device. After receiving 302 the travel request, in this embodiment, the server 102 retrieves 304 additional information related to the traveler and/or destination(s). Such additional information retrieved 304 by the server 102, from memory 204, may be associated with a travel profile of the traveler. Specifically, in the exemplary embodiment shown in FIG. 3, the server 102 retrieves 306 a travel profile for the traveler, as part of retrieving 304 additional information. The travel profile may be maintained by the organizer 112 and may include, for example, confirmation of the traveler's name (e.g., confirmation that the traveler is in fact an employee associated with the organizer), the traveler's corporate title, the traveler's corporate department, and any special travel exceptions for the traveler (see FIG. 4A, and the additional information previously described). The additional information, and/or the traveler profile, may further include, for example, additional personnel information, predetermined travel preferences for the traveler, traveler feedback, and travel history for the traveler to the destination and/or other destinations, etc.

Part or all of such additional information may be stored, for example, in memory 204 of the server 102, and/or another memory 204 or multiple memories 204 within the system 100, and accessible to server 102. Additionally, or alternatively, part or all of the additional information may be retrieved from a third party, such as, for example, a risk assessor or travel service, via network 106, or other entity (e.g., other analysts that use open sources, contracted risk management servers, locally based proprietary security specialists, hotel tracking tools, etc.).

The server 102, in the exemplary embodiment, next assigns 308 a risk value to the travel request. The assigned risk value may be based on travel risks at the destination, or a region of the destination, as well as identity of the traveler, etc. The risk value may be provided on a scale, for example, from high risk to low risk, etc. Further, the risk value may be obtained by the server 102, via network 106, from one or more third-parties who routinely, or occasionally, maintain such risk values for multiple destinations. Additionally, or alternatively, the risk value may be independently determined, calculated, etc. by the server 102, for example, based on various factors, such as, for example, travel destination, identity of the traveler, crime statistics, prior travel incidents, destination governmental stability, international reputation, information from other analysts, information from locally based proprietary security specialists, etc. Non-limiting examples of a risk value that may be assigned 308 by the server 102 include a Tier 1 risk value indicating a very high risk (e.g., assigned to an extreme risk destination, etc.), a Tier 2 risk value indicating a high risk (e.g., assigned to an elevated risk location, etc.), and a Tier 3 risk value indicating a moderate risk (e.g., assigned to a lower risk location, etc.). As an example, a Tier 1 risk is associated with the exemplary travel request shown in FIGS. 4A-4C, where the travel destination is Kabul, Afghanistan. It should be appreciated that a different number of risk values may be used by the server 102, and/or may be available to the server 102, to assign to one or more travel requests.

In some embodiments, upon assigning a risk value to the travel request (e.g., a Tier 1 risk value, a risk value higher than a predefined risk value, a risk value higher than a predetermined threshold, etc.), the server 102 then solicits 310, for example, from the organizer 112 (e.g., of the travel), approval of the travel request. Such organizer 112 of the travel may include a supervisor of the traveler, or other person associated with the employment of the traveler or the activities and/or responsibilities of the traveler. The organizer 112 of the travel may further include one or more individuals associated with the travel destination who have particular insight into traveler risk for the travel destination. Such individuals may be able, in some implementations, to provide an additional insight (in addition to the assigned risk value) into whether the traveler is safe to travel to the destination for the duration of the travel. The same or different types of approvals may be solicited from persons other than the organizer of the travel, including, for example, the traveler. Additionally, or alternatively, it should be appreciated that the server 102 may solicit one or more approvals (related to the travel request or travel plan, for example) before or after other operations in the method 300. Approvals may involve various criteria, including, without limitation, the associated risk of the destination, the value of the travel, business concerns, company policy, personal circumstances, etc. If a travel request is cancelled for any reason during any of these approvals, the traveler may, in some embodiments, receive a notification such as by email message, text message, etc., indicating the cancellation and one or more reasons the request was cancelled, or no reason the request was cancelled.

With continued reference to FIG. 3, the server 102 next compiles 312 a travel plan. The travel plan includes at least part of the information included in the travel request, and security measures intended to confirm and/or account for the safety of the traveler, during his/her travel.

In the illustrated embodiment, and indicated by the dotted lines, compiling 312 the travel plan optionally includes identifying 314 travel directives for the travel destination and assigning 316 predetermined check-in times. Travel directives may include, for example, suggestions and/or precautions, for behavior in the destination to promote traveler safety, and in some embodiments, explanation(s) of the perceived risks associated with the travel destination, or aspects thereof. Exemplary directives include suggested curfews, suggested modes of transportation, hotel recommendations, etc. The predetermined check-in times are times at which check-in communications are sent to the traveler, thereby prompting the traveler to check-in. Check-in times, as used herein, may include predetermined check-in times and/or may refer to times at which the traveler will be at particular locations, for example, without limitation, times corresponding to a start of the trip, arrival of the traveler at an airport, arrival of the traveler at the location, arrival of the traveler at various destinations at the location, arrival of the traveler at home, etc. As an example, the travel directives and predetermined check-in times for the travel plan associated with travel request of FIGS. 4A-4C are incorporated by the server 102 directly in the travel request page (see FIGS. 4B and 4C).

The travel plan may be automatically compiled 312, by the server 102, based on one or more defaults. In one example, where the risk is Tier 1, the default travel plan may include predetermined check-in times every five hours, with additional predetermined check-in times for arrival and departures from certain places. The travel plan may further be based on numerous inputs from, or modified by, the organizer 112 or other user, at one of the communication devices 104. Such inputs and/or modification may account for the risk value, travel destination, traveler identity, traveler profile, or other consideration, etc. In one example, the server 102 may initially identify (e.g., auto-populate in the travel plan, etc.) travel directives from a list of predefined directives for a given destination, and then permit the organizer of the travel to modify the directives as needed (e.g., as suggested by regional personnel, based on the traveler's profile, etc.). As shown for the exemplary travel request in FIGS. 4A-4C, the travel directives may also be provided in editable format such that the organizer can specifically tailor them as desired (see FIG. 4B).

Similarly, the server 102 may initially assign 316 check-in time(s) for travel based on a default schedule of check-in times associated with, for example, a set of activities typically included in trips, including arrival at airports, arrival at hotels, etc. The check-in times may then be modified, by the organizer 112, as needed, based on, for example, the risk value assigned to the trip, the identity of the traveler, the traveler's profile, etc. Moreover, the organizer 112 is able to review and revise the travel plan, manually, to modify it based on any criteria associated with the traveler, destination, etc. Regardless of the inputs and/or modifications provided by the organizer 112 (even if each component of the travel plan is input manually by the organizer), the server 102 compiles 312 the electronic travel plan and stores it in the memory 204. Additionally, in some embodiments, the server 102, automatically, or at prompting from the organizer of the travel, may also update the travel plan, during the trip, to account for changes in the traveler's itinerary during the trip (e.g., changes in flight times, changes in meetings, etc.). Further, in at least one embodiment, the travel plan may include one or more predetermined check-in locations for the traveler in or around the destination, or as dictated by a travel itinerary.

It should be appreciated that the check-in times included in a travel plan may vary depending on the various aspects of the travel, the individual travelers, and/or the travel destinations. As an example, for a traveler on a trip having a lower-risk value, the travel plan may include only the predefined travel directives and may include only two predetermined check-in times. Alternatively, if the same trip has a higher risk value, the travel plan may include the predefined travel directives for the destination, as well as additional travel directives specific to the destination (e.g., avoid ABC business on 1st Street, etc.), and may then also include the default check-in times, along with multiple additional predetermined check-in times to account for the assigned risk value. The server 102, or organizer 112, may further request particular itinerary information from the traveler (e.g., meeting schedules, meal schedules, hotel schedules, etc.), if not included with the original travel request, in order to further revise the travel plan. As another example, for a traveler who routinely travels with security (e.g., a CEO of a company, etc.) or a traveler who resides in the travel location, the travel plan may include no travel recommendations and/or no predetermined check-in times. In yet further examples, factors, such as traveler experience in the destination, nationality, residence in the destination, travel frequency, etc., may also be considered in assigning check-in times.

It should be appreciated that the travel plan can be tailored to the particular traveler and/or destination, such that a sufficient level of interaction with the traveler is achieved to confirm and/or account for the traveler's safety, but without unnecessarily inconveniencing the traveler. In this manner, methods and systems herein may provide substantial flexibility to account for numerous different travelers, characteristics of the travelers, and travel scenarios, and specifically, their individual security needs.

With further reference to FIG. 3, once the travel plan is compiled 312, the server 102 sends 318 the travel plan (or a part thereof) to the traveler for approval. For example, the server 102 may send an email, via the network 106, to the traveler, with a link provided in the email to the travel request where the traveler can review the travel plan and provide his/her acknowledgement to abide by the travel plan (e.g., the traveler may be required to check a box on the travel request to thereby indicate agreement, acceptance, and/or acknowledgement of the travel plan, etc.). In some aspects, the acknowledgement of the travel plan may also operate to educate the traveler on the travel destination, and any associated risks therewith, prior to start of the travel. In some embodiments, acknowledgement by the traveler may be required prior to approval of the trip (e.g., by the organizer of the travel, etc.), and/or proceeding to other operations.

In addition to the above, the server 102 may limit the time from receipt of the travel request and/or compilation of the travel plan, or other operation, until the start date of the travel. Specifically, for example, when a travel request is for a high risk destination, factors implicating the safety of the traveler may change frequently. If a travel plan is compiled three weeks prior to the travel, for example, subsequent events in the high risk destination may implicate additional travel directives and/or a different frequency of predetermined check-in times. Not only the amount of information in the travel request, and additional information retrieved, but the accuracy of the information on the date of travel affects whether the travel plan is the best for the traveler or corresponding trip. In one or more preferred embodiments, therefore, for high risk destination, a travel plan may not be compiled more than five, ten, 15 or 20 days, or one month, two months, etc. in advance of the start date of the travel. In other embodiments, the server 102 may proceed to compile the travel plan regardless of when the travel request was submitted.

In the exemplary embodiment, after the travel plan has been compiled 312, and the travel is approaching or imminent, the server 102 schedules 313 a check-in communication for each predetermined check-in time included in the travel plan. In the exemplary embodiment, check-in communications are often scheduled after approval has been received (when required) and the travel has been confirmed. Here, the travel may be confirmed by the traveler and/or organizer of the travel to thereby indicate, to the server 102, that the travel is indeed going to happen, and has not been cancelled. The confirmation may be part of an approval, travel request, or other operation associated with receiving the travel request or compiling the travel plan, but is preferred to be close in time to the start date of the travel, to thereby reduce the risk the check-in communications are scheduled for travel which is ultimately cancelled.

When multiple check-in times are included in the travel plan, the check-in communications may be scheduled in parallel or sequentially. In other words, each check-in communication may be scheduled before the trip begins, at the predetermined check-in times, so that the server 102 sends the check-in communication regardless of whether other check-in communications have been acknowledged, as described below. Conversely, when scheduled sequentially, the server 102 does not proceed to the next predetermined check-in time, until an acknowledgment is received for the prior check-in communication. In such embodiments, as described below, reminder and/or other final communications may be sent, by the server 102, which are associated with the un-acknowledged check-in communication.

Referring again to FIG. 3, the server sends 320 the check-in communication, which may include, without limitation, email messages, text messages (e.g., SMS messaging, MMS messaging, TMS messaging, etc.), or other electronic or voice messages, to the communication device 104 associated with the traveler at the predetermined check-in time. The check-in communication may cause the communication device 104 to generate a tone, ring, vibrate, display an indicator, or otherwise visually and/or audibly inform the traveler of the check-in communication. In at least one embodiment, the check-in communication is an automated voice call to a portable communication device associated with the traveler.

The traveler then has a predefined time interval to acknowledge the communication. The time interval may be about one minute, about five minutes, about 10 minutes, about 30 minutes, or another time interval, etc., and time intervals may be different for different check-in communications due to, for example, the predetermined check-in time. In one example, a check-in communication associated with the arrival, via airplane, of the traveler at the destination may have a longer time interval due to frequent delays associated with air travel. Conversely, in another example, check-in communications scheduled for travel into high risk areas for meetings (as compared to the hotel) may have a shorter time interval.

To track the time interval, the server 102 may initiate a timer based on the time interval, or the server 102 may calculate a required response time (e.g., the final check-in time, etc.) by adding the time interval to the predetermined time. In some embodiments, the server 102 may further send the traveler a reminder communication within a reminder interval of the predetermined check-in time. Like the time interval, the reminder interval may be of any duration. The reminder may be sent, from the server 102, prior to or after the associated predetermined check-in time. When the reminder is sent prior to the predetermined check-in time, in some embodiments, no response is required of the traveler (e.g., where the traveler is required to respond to a later check-in communication). Conversely, in other embodiments, when the reminder is sent, by the server 102, after the predetermined check-in interval, the reminder may instruct the traveler to respond to the prior check-in communication.

After sending a check-in communication, the server 102 determines 322 if the acknowledgement is or has been received within the predefined time interval. The traveler may acknowledge the check-in communication in a variety of different ways. For example, where the check-in communication is a text message, the traveler may respond via text message to acknowledge the check-in communication. And, where the check-in communication is an email, the traveler may simply reply to the email. In another embodiment, where the check-in communication is an email, the traveler may simply open a link in the email to provide acknowledgement. In other examples, the traveler may initiate a phone call to an automated voice system to provide an acknowledgement. While certain ways of acknowledging the check-in communication may be preferred (e.g., to incorporate with the automated system, or utilize an efficient communication path, such as text messaging, etc.), it should be appreciated that the traveler (broadly, participant 114), based on the type of check-in communication, or not, may acknowledge the check-in communication in any number of different ways. Moreover, in at least one embodiment, where the travel plan includes at least one predetermined check-in location, the communication device 104 associated with the traveler may include a GPS device, and automatically acknowledge (with or without traveler input) the check-in communication when the traveler is present at the check-in location.

If the server 102 receives 322 acknowledgement from the traveler within the time interval of (before or after) the predetermined check-in time, the server 102 completes 324 the check-in communication. The server 102 then determines 326 if all check-in communications in the travel plan have been acknowledged. And, if the check-in communication is the final communication in the travel plan, or the total number of completed check-in communications equals the number of check-in communications in the travel plan, the server 102 further completes 328 the trip (e.g., closes the travel request, etc.). Conversely, if additional check-in communications are pending, the server 102 continues in executing the travel plan.

Conversely, if the server 102 does not receive 322 acknowledgement from the traveler within the time interval, the server sets 330 a warning event. The particular action taken by the server 102 when the warning event is set, in various embodiments, is dictated by the severity of the missed check-in communication or overdue acknowledgement, taking into account, for example, the number of unresolved missed check-in communications for the travel, the identity of the traveler, the travel destination, etc. Such actions to notify the organizer of the travel, traveler, or other person may range from minor (e.g., sending, via the server 102, a communication to the traveler indicating that the traveler has not acknowledged a prior check-in communication and giving the traveler an extended time interval to acknowledge, sending a communication to the organizer, sending an alert to one or more communication devices associated with the organizer, such as pop-up or message on a status page, etc.) to more extreme (e.g., sending, via the server 102, a warning communication to security or regional personnel who may then attempt to contact the traveler, in person, electronically, and/or by notifying local authorities, etc.).

In one particular example, the action may include sending an email message, by the server 102, to the organizer to notify the organizer of the warning event. In one example, the email message may be titled “Notification of Late IMOK Check-In”, and may include a message such as “Dear Organizer, The following High Risk Travel IMOK check-in requirement is late. Check-In Number: 5888. Check-In Required By: MM/DD/YYYY 12:00:00 PM (Central Standard Time). Check-In Required By: MM/DD/YYYY 8:00:00 PM (Eastern European Time). Traveler: Williams, Bill (e333333). Country: Egypt. City: Cairo. Arrival: MM/DD/YYYY 12:20:00 AM (Central Standard Time). Arrival: MM/DD/YYYY 8:20:00 AM (Eastern European Time). Departure: MM/DD/YYYY 1:25:00 PM (Central Standard Time). Departure: MM/DD/YYYY 9:25:00 PM (Eastern European Time).” It should be appreciated that the particular action may be any appropriate action given the relevant facts to the missed check-in communication.

As represented by the dotted line around operations 320n, 322n, 324n, 330n in FIG. 3, in this embodiment, the above operations are repeated by the server 102 for each scheduled check-in communication of the travel plan. It should be appreciated that, as explained above, any number of check-in communications may be included in a travel plan. For each additional predetermined check-in time, scheduled for travel, duplicates of the above operations are included, with each operating substantially the same.

As an illustrative example, the following describes exemplary check-in operations for a travel plan having two predetermined check-in times, one at 1:00 PM on Day 1 of a trip and another at 8:00 AM on Day 2 of the trip. In this example, at 1:00 PM on Day 1, a server sends the traveler a first check-in communication. Here, the check-in communication includes an email message containing a secure link, to which the traveler can acknowledge by opening the link on his/her portable communication device. In some aspects, the link may open the travel request for the traveler and allow the traveler to view status of all check-in communications for the trip, and acknowledge a pending check-in communication or a missed/overdue check-in communication. Alternatively, or additionally, the email message may include a check-in number which would allow the user to call the server and enter the check-in number to thereby provide acknowledgement. In other embodiments, simply opening a link in the email provides sufficient acknowledgement of the check-in communication.

In any case, upon sending the first check-in communication, the server also sets a time interval of, for example, four hours in which to receive the traveler's acknowledgement. As previously described, if the server receives the acknowledgement within the time interval, it will complete the first check-in communication. However, at 5:00 PM on Day 1, if the server has not yet received acknowledgement of the first check-in communication, it will send the traveler a warning communication indicating that the traveler missed the first check-in communication. The server will also provide the traveler with an additional time interval of, for example, four additional hours to provide the acknowledgement, or a different shorter or longer interval associated with reminders and/or warning communications (this may repeat for each missed communication). At 9:00 PM on Day 1, if the server still has not received acknowledgement of the first check-in communication, it will send yet another warning communication to the traveler, and either repeat doing so until acknowledgement is received, or take more invasive action, such as contacting security personnel of the organizer who will then attempt to call, locate, etc. the traveler. At 8:00 AM on Day 2, the server sends the traveler a second check-in communication (again, an email message containing a secure link), regardless of whether the response to the first check-in communication has been received. And, the server again sets a time interval of, for example, four hours in which to receive the traveler's acknowledgement of the second check-in communication. Then, if at 10:00 AM on Day 2, in this example, the server receives acknowledgement of the second check-in communication, it will complete both the first and second check-in communications, and terminate the warning communications associated with the first check-in communication.

In this example, the check-in communications are handled by the server 102 in parallel or independently of each other. The server 102 sends check-in communications at predetermined check-in times (as shown in FIG. 3, for example) regardless of whether earlier check-in communications have been completed. Also in this example, upon receiving acknowledgement of check-in communications, the server completes all uncompleted prior check-in communications. In other embodiments, however, check-in communications may be dependent upon each other, such that the server 102 only sends check-in communications at subsequent check-in times if the earlier check-in communications are complete. In addition, in other exemplary embodiments the server 102 may only complete check-in communications upon receipt of acknowledgement for the particular check-in communications (taking this approach in the example above, the first check-in communication, and the associated warning communication, would remain open until the traveler actually acknowledged the first check-in communication).

In addition to, or as part of, the method illustrated in FIG. 3, the server 102 stores and manages information associated with the method 300. Specifically, for example, the server 102 stores travel requests, travel plans, and traveler profiles in memory 204, and also facilitates the travel requests by sending pages, such as shown in FIG. 4A-C to travelers.

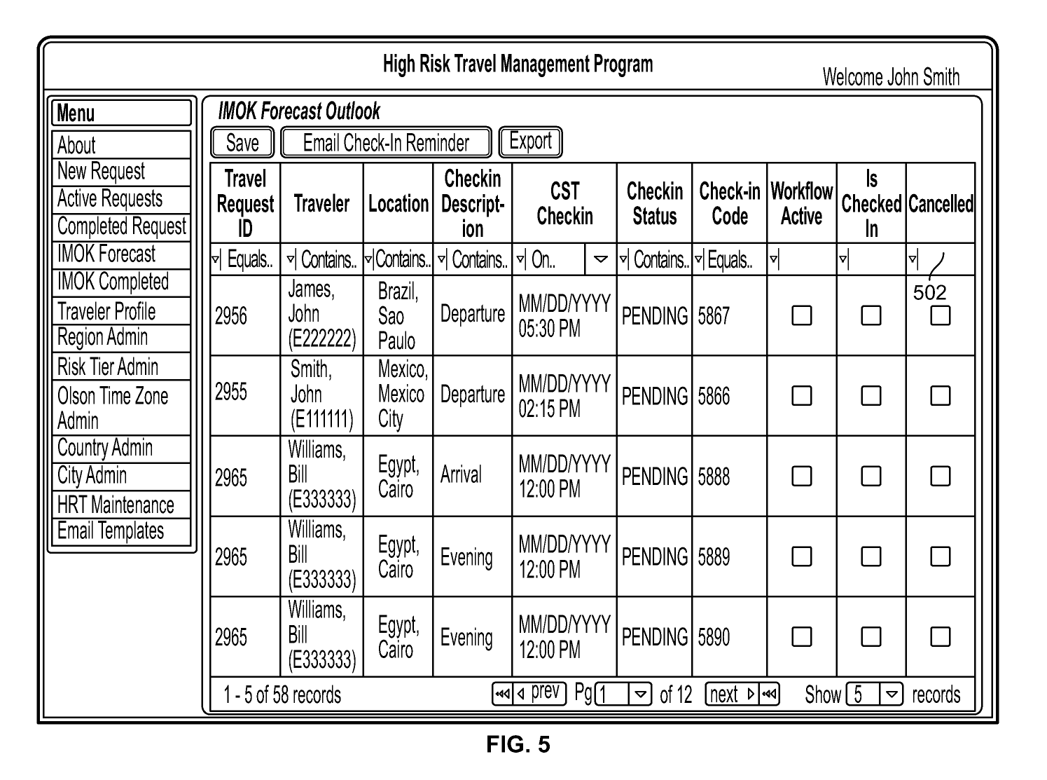

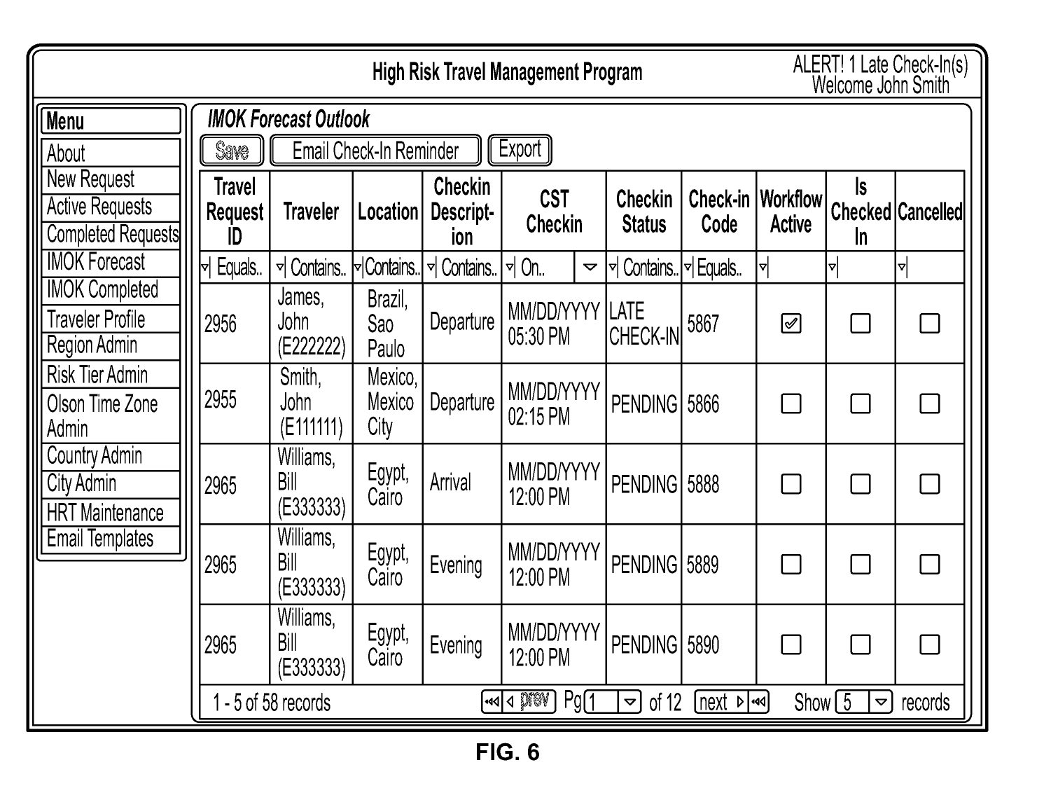

Moreover, the server 102 permits the organizer of the travel, at one or more pages delivered to a communication device (or directly to server 102, at a display device 206), to review and/or modify travel requests, travel plans, traveler profiles, and scheduled check-in communications (by traveler or by group of travelers), other communications, and warning events. As shown, for example, in FIGS. 5 and 6, multiple check-in communications for multiple travelers can be reviewed in a single scrolling or progressive status page, together in real time. In addition, warning events can immediately be viewed, as they occur, on the status page (compare FIG. 5 and FIG. 6), so that appropriate action can be taken. Through these pages, not only can the number of warning events be tracked (e.g., as a heads-up display at the top of the page), but the particular travelers triggering the warning events can be identified (e.g., in the grid-view via the check-mark).

The server 102 stores the above travel requests and travel plans in a database in memory 204, such that pages indicative of submitted travel requests, approved travel requests, cancelled travel requests, active travel requests (e.g., travel requests for trips where travelers are at the travel locations, etc.), and completed travel requests may be viewed in one or more status pages. The data may be displayed in a variety of different status pages to the organizer 112 at a communication device 104, including the exemplary status page of FIG. 5. As shown, the status page may include names of the travelers, their travel destinations and dates, check-in communications and/or predetermined check-in times for each travel plan and/or traveler (see FIG. 5). In addition, in this exemplary embodiment, the status page may be searchable (at 502) to show particular information of interest, from the database, to the organizer of the travel (e.g., next pending check-in times, etc.). In some embodiments, travel requests or travel plans (such as shown in FIGS. 4A-C) may be viewed by selection or input to a status page include a link to the travel request or travel plan.

Further, one or more status pages may include multiple travel requests for multiple travelers associated with an organizer of the travel. In some embodiments, a status page includes a listing of check-in communications, listed in order of next in time for all of the ongoing travel for the organization, for example, all pending check-in communications (e.g., a forecast outlook of such communications, etc.), all completed check-in communications, and all missed check-in communications. In some embodiments, the included information specific to individual travelers may be viewed by the travelers, for example, through the travel request.

As shown in FIG. 5, the predetermined check-in times may be included in the status page as a normalized time zone, such as Central Standard Time (CST). In this exemplary embodiment, the server 102 converts the predetermined check-in times from the local time of the communications (in the time zone of the travel destination) to a common reference time. Different reference times may be used in other embodiments, such as, for example, global standard time. In this manner, the organizer of the travel reviewing and/or managing the travel is able to view impending check-in communications relative to one another. For example, if one traveler is in Argentina, and another traveler is in India, it is difficult to immediately perceive when the check-in communications would be sent, if the check-in times were displayed in local destination time. It is preferred to list the check-in times in a standard time to avoid manual conversion, by the organizer of the travel, of times at the destinations. The common reference time, therefore, permits the organizer of the travel to better compare and plan for the impending check-in communications.

When the server 102 initially receives a travel request from a traveler, it stores the travel request in memory 204. As the travel request is subjected to the operation described herein, the server 102 designates the travel request accordingly. For example, when a travel request is cancelled, the server 102 designates it cancelled, whereby it would be included in a status page of cancelled travel requests. Alternatively, when a travel request is approved, the server 102 designates the travel request approved, whereby it would be included in a status page of approved travel requests (e.g., requests that are pending, requests that are planned to start at some future date, etc.). In various embodiments, the servers 102 applies similar designations upon complete operations herein (e.g., approved, scheduled, pending, active, completed, missed, warning, etc.) to the travel requests, travel plans, and individual check-in communications in the database to permit the information to be included in one or more status pages to the organizer of the travel.

Referring again to FIG. 5, the status page, from the server 102, permits the organizer of the travel to review any of the above databases in a variety of different ways. It should be appreciated that different pages, including different lists and/or other information may be included in other status pages, from the server 102.

The systems and methods described herein provide organizers with the ability to manage (e.g., initiate, schedule, update, oversee, monitor, track, etc.) travel for participants, particularly higher-risk travel where the participants may be exposed to greater risks during travel. The systems and methods herein may further provide review and/or approval processes for the travelers to ensure accuracy of their travel information, as well as to acknowledge travel directives for the participant (and, in effect, provide the participants with a view of the possible risks associated with the travel and the organizer's participation in their travel). In addition, the check-in management systems and methods herein allow for monitoring safety status of the participants through automated tracking of check-in communications (see the method 700 described in more detail hereinafter). This, in turn, allows for accurate and quick responses if needed, for example, for missed check-in communications, etc. Further, the systems and methods herein may permit easy and accurate scheduling and monitoring of travel through automatic listings (and automated creation of desired data sets) of current travel and participants, their check-in times, their check-in status, and their risk areas (e.g., an active directory of travel, etc.).

With reference now to FIG. 7, the exemplary method 700 is provided for managing check-in communications, which are associated with a trigger event. Trigger events may include, without limitation, emergencies, security incidents, security tests, security drills, natural disasters, pandemics, acts of terrorism, or other events, which may cause the organizer 112 to check on a status of the participant(s) 114. In one example, if a terrorist attack occurs in ABC City, an organizer (e.g., organizer 112), with employees at its facility in ABC city and with travelers visiting the facility in ABC city (e.g., participants 114), may use the check-in management systems and methods herein to check the status of its employees and travelers, so that, in some embodiments, the organizer 112 may take action to assist the employees and travelers. In another example, the check-in management systems and methods herein may be used to confirm that certain security actions have been successfully taken in emergency situations, special events, etc. (e.g., requesting a check in for certain participants after alarms have been set/tested by the participants, after patrols have been performed by the participants, or after status of others have been verified by the participants, etc.).

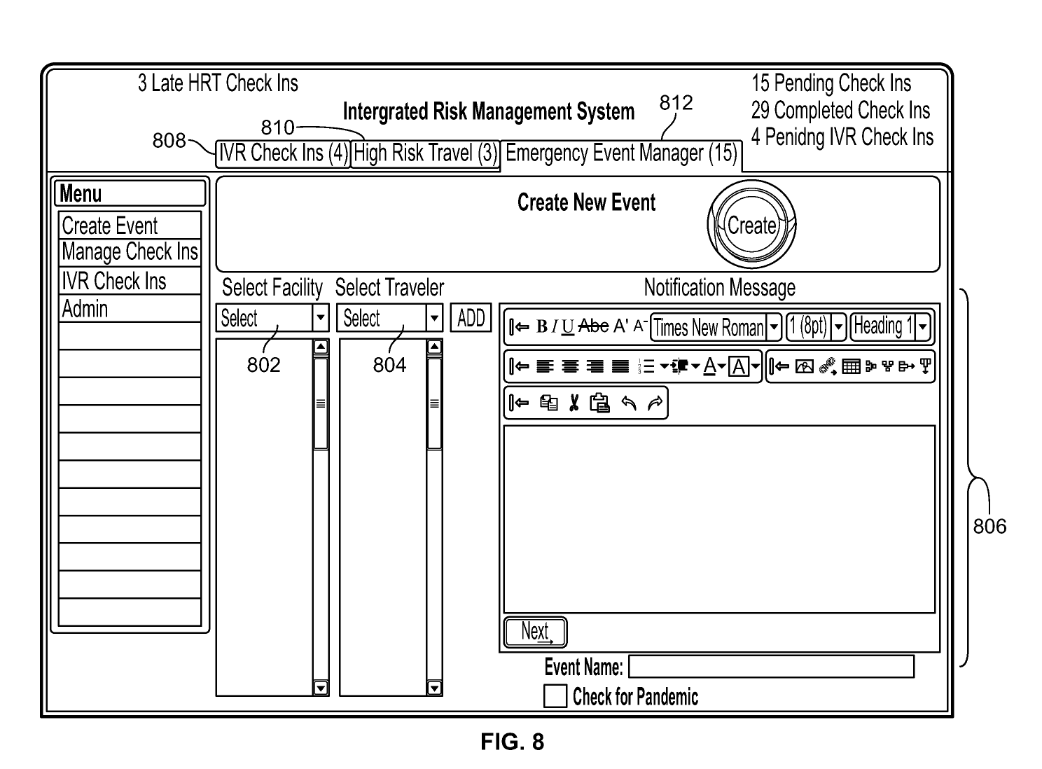

Initially, upon the occurrence or in anticipation of a trigger event, an organizer 112 creates a notification request for submission to the system 100, and in particular, the server 102. In some embodiments, the notification request may be an electronic form completed by the organizer 112 through a communication device 104, or in other embodiments, may be in a different format, such as paper form or email. In one example, the notification request page illustrated in FIG. 8 may be used by the organizer 112 to create the notification request. The notification request provides an indication, to the server 102, of which participants 114 might be affected by the trigger event, and thus should be checked. The participants 114 may be indicated expressly in the notification request, such as by name, identification number, or other distinguishing information. Alternatively, or additionally, the participants 114 may be indicated indirectly by including a location at which the participant may be traveling, a facility at which the participant 114 may be employed, or other indicator unspecific to a particular participant 114. These indirect indicators in the notification request may be preferred, in some embodiments, to add participants 114 by group, rather than indicating numerous participants 114 individually.

In the exemplary page shown in FIG. 8, drop-down menus 802, 804 include facilities and individual participants 114, for use in indicating who may be affected by the trigger event. The facilities drop-down menu 802 may include all facilities associated with the organizer 112, or a subset of such facilities based on one or more criteria, such as, for example, the location of the trigger event, the type of trigger event, the severity of trigger event, etc. Similarly, the individual participants drop-down menu 804 may include all participants 114 associated with the organizer 112, or a subset of such participants 114 based on one or more criteria, such as, for example, the location of the trigger event, the type of trigger event, the severity of trigger event, a selected facility, etc.

As shown in FIG. 8, in addition to the facility and participant selection fields, other fields 806 permit the organizer 112 to name the trigger event, indicate whether or not the trigger event is a pandemic, and create a custom notification message. The notification message may, for example, include instructions or information about the trigger event. In one example, the notification message includes instructions for how to identify symptoms of a pandemic, which is the subject of the trigger event. In another example, the notification message includes a status of the natural disaster, such as an earthquake, hurricane, or tornado, and the expected or planned response of emergency personnel.

It should be appreciated that a number of different notification request pages may be used with the system 100. Other notification request pages, or forms, may be different than the example page of FIG. 8. For example, notification requests may include fields to request, from the organizer 112 (or the server 102), information, including the type of trigger event (e.g., emergency event, security event, natural disaster, pandemic, act of terrorism, etc.), severity of trigger event (similar to the risk values described above with reference to method 300), the location of the trigger event (e.g., country, state, region, street address, etc.), affected radius (e.g., within 10 miles of a street address), the time/date of the trigger event, or any other information useful in identifying participants 114 that may be affected by the trigger event, or efficiently communicating with such participants 114. Moreover, notification requests may include, from the organizer 112 (or the server 102), instructions for sending check-in communications to the participants (as described below), including, for example, frequency of check-in communications, preferred communication paths (e.g., text messages, etc.), actions to be taken for warning events, predefined positive or negative conditions to be included in one or more acknowledgements, and/or any other instructions that may permit the efficient check-in with participants 114, etc.

In at least one embodiment, the notification request may be created automatically by the server 102 when a trigger event is detected (e.g., by monitoring and comparing current events around the world to predefined parameters to determine if any of the events are trigger events, etc.).

Once created, the notification request is transmitted to and/or received by the server 102 at 702, for example, from one of the communication devices 104 or another device. The server 102 then identifies particular participants 114 that may be affected by the trigger event, based on the notification request at 704 (and the participants 114 indicated in the travel request). In numerous embodiments, the server 102 identifies the participants 114 by searching in a participant database, stored in memory 204, for participants that are indicated in the notification request. For example, where the notification request indicates a facility (or more broadly, a location), the server 102 searches in memory 204, in an active directory of participants, to determine which participants are employed at the facility. In other examples, different indirect indicators of participant(s), or group(s) of participants, included in the notification request may be searched, by the server 204, to identify the participants 114. In yet another example, the server 102 may search for the participant by name, ID number (e.g., an employee number, etc.), or other identifying information included in the notification request. As part of identifying the participants 114, the server 102 retrieves contact information (e.g., phone number, email address, etc.) for each participant 114, which will be used to send check-in communications. In some aspects, the system 100 may also allow for manual addition or deletion of contact information for participants 114 to account for lost or invalid phone numbers, newly obtained communication methods that are not stored in active directories or in the server 102. This can be helpful where the participants 114 travelers use assigned temporary phones (e.g., satellite phones, etc.), personal devices, etc.

Furthermore, in identifying the participants 114 at 704, the server 102 may include or exclude certain participant for a variety of reasons. For example, the server 102, when searching for participants 114 associated with a location, may search in the participant database for a travel status (e.g., out of office, in the office, travel, vacation, etc.) associated with participant 114 (e.g., in relationship with method 300, etc.), who is indicated by the notification request, and exclude participants 114 that are employed at a facility in the location, but traveling away from the facility. In this example, the participant 114 would not be subject to the check-in communications described below, because the participant 114 would likely not be affected by the trigger event. In another example, certain participants 114 may always be included in the notification request regardless of their location, such as where the facilities at the location of the trigger event are in some way the responsibility of the participant (e.g., a plant manager, division supervisor, etc.).

After identifying the participants 114, the server 102 then sends a check-in communication at 706, via the network interface device 210, to each of the identified participants 114. The check-in communication may include, without limitation, email messages, text messages (e.g., SMS messaging, MMS messaging, TMS messaging, etc.), or other electronic or voice messages described herein. In at least one embodiment, the check-in communication is provided from an automated voice call system (e.g., an integrated voice response (IVR) system) to a portable communication device associated with a participant 114. The check-in communications may include, depending on the type, a title (e.g., as the subject of email), a notification message (e.g., the message received through the page of FIG. 8), and a check-in number to track each communication. Different information may be included in other check-in communications depending, for example, on the type of trigger event, the particular participant(s) 114, the location of the trigger event, the severity of the trigger event, etc. For example, during certain trigger events, a text message check-in communication may be preferred, because text messages are queued until completed and are battery efficient (as compared to voice calls), etc.

Furthermore, the check-in communication may include positive and/or negative conditions, which may be used by the participant in acknowledging the check-in communication. For example, check-in communication may solicit a status of the participant 114, such as “OK” or “NOT OK”, or “SICK” or “NOT SICK” (for a pandemic). For email messages, the options may be associated with buttons or links, for example, on a display of a communication device that can be selected by the participant 114 (e.g., one link for “OK” and another link for “NOT OK”, etc.). For voice messages and/or text messages, the options may be associated with a number, for example a number on an input device of a communication device, that can be actuated (e.g., 1 for “OK” or 2 for “NOT OK”). Various other conditions may be included in a check-in communication depending, for example, on the type/severity of trigger event, the participants 114, the location of the trigger event, efficiency of the communication path to the participant 114, etc.

After sending the check-in communication, the server 102 determines if the participant 114 has acknowledged the check-in communication at 708. The participant 114 may acknowledge the check-in communication in a number of different ways. For example, where the check-in communication is a text message, the participant 114 may acknowledge the check-in communication via text message. And, where the check-in communication is an email, the participant 114 may simply reply to the email. In other examples, in response to a phone call from/to an automated voice system, the participant 114 may acknowledge the check-in communication by simply pressing a button, or possibly entering an ID number.

In numerous embodiments, after sending the check-in communication, the server 102 designates the check-in communication as pending, until an acknowledgement is received. In some embodiments, the server 102 determines if the participant 114 has acknowledged the check-in communication within a predefined time interval after the check-in communication is sent, such as five minutes, 10 minutes, 30 minutes, or another time interval. The duration of the time interval may be based on, for example, the severity/type of the trigger event, the identity of the participant(s) 114, the location of the trigger event, etc. If the check-in communication is not acknowledged within the time interval, the server optionally (as indicated by the dotted line) sets a warning event at 710, as further described below. Where there is not a time interval, the server 102 will understand the check-in communication to be pending, until an acknowledgement is received or the organizer 112 takes action.

In this exemplary embodiment of FIG. 7, when the acknowledgement is received from the participant 114, the server 102 designates the check-in communication complete at 712. And then, the server 102 determines whether the acknowledgement includes a negative condition at 714. For example, an acknowledgement may indicate the participant is “NOT OK” or “SICK.” Other conditions may be included in the acknowledgement, either selected form options provided in the check-in communications, or entered by the participant 114. Conditions may be included in the acknowledgment, so that it is clear which conditions are negative, and which conditions are positive. In at least one embodiment, no condition in the acknowledgement may be understood as either a positive or negative condition. For example, where a check-in communication is an email, a simple reply (without addition text from the participant 114) may be understood as a positive condition. In a different example, where the check-in communication prompts the participant to enter some personal information, such as an ID number, but the participant 114 does not, the acknowledgment may be understood to include a negative condition. By permitting the participants 114 to include positive and negative conditions, the server 102 allows the participant 114, not only to acknowledge the check-in, but also to provide additional pertinent information to the organizer 112. This may permit the organizer 122 in some embodiments to concentrate resources on certain ones of the participants 114 affected by the trigger event, or affected most severely by the trigger event. Each type of response/acknowledgement can be separately tracked/monitored.

Further, in at least one embodiment, if conditions other than the predefined options are received, or acknowledgements are received from personnel other than participants 114, the server 102 may assign a unique classification (e.g., a loose check-in classification, etc.) to the responses and/or acknowledgements and request further review by the organizer 112 and then separately take further action for those acknowledgements (e.g., log and/or track each for manual review).

Referring again to FIG. 7, if the acknowledgement from the participant 114 includes a negative condition at 714, the server 102 sets a warning event at 710. Upon setting the warning event, as described above, the particular actions then taken by the server 102, or the organizer 112, will vary widely depending on various criteria, including, without limitation, the severity/type of the trigger event, the identity of the participant(s) 114, the location of the trigger event, the time since the check-in communication was sent, the negative condition indicated, the action available to be taken, etc. For example, where the negative condition indicates a medical condition, the server 102 notifies the organizer 112, who may take action to coordinate medical care for the participant 114. Further, in some embodiments, where no acknowledgement is received, the server 102 may send one or more reminder communications to the participant 114. The interval and frequency of the reminder communication may be based on the severity/type of trigger event, the identity of the participant(s) 114, available communication paths, etc.

Further, in certain embodiments, the organizer 112 may take action for pending check-in communication where the lack of acknowledge for a period of time indicates an issue. In one example, where the trigger event is an earthquake, after sending check-in communications to one hundred different participants, the organizer 112 may then wait 3 hours (or more or less) and, at which time, if eighty-four of the one hundred check-in communications have been acknowledged, for example, then take any action regarding the still pending sixteen check-in communications.

It should be appreciated that more than one check-in communication may be sent to each participant 114 associated with the trigger event. The frequency of such check-in communications may be dependent on the type/severity of trigger event, the identity of the participant 114, the location of the trigger event, a predetermined schedule, etc. Repeated check-in communications may be beneficial where the status of the participants 114 may change over time. For example, if the trigger event is identified as a pandemic, the server 102 may send check-in communications to the participants 114 every 24 hours, to confirm continued safety and health of the participants 114. Moreover, the check-in communication may further be tailored to the status of the trigger event and/or participant 114. For example, where emergency personal have begun to enter the location of the trigger event, the notification message (included in the check-in communication) may be altered to include the new information. In another example, where the participant 114 had previously indicated a negative condition, the notification message may elicit a status or further detail about the condition. The multiple check-in communications are illustrated in FIG. 7 and denoted by the dotted box around operations 706n, 708n, 710n, 712n and 714n. In addition to sending multiple check-in communications to a participant 114, exemplary method 700 provides for sending check-in communications to multiple participants 114, also indicated by the same dotted box of FIG. 7.

While the exemplary method 700 provides that the server 102 determine whether the acknowledgement includes a negative condition, it should be appreciated that this operation may be omitted in other embodiments. Conversely, the inclusion of a condition in an acknowledgement may be employed in other method embodiments, including the exemplary method 300, even where no trigger event has occurred.

It should be understood that exemplary method 700 for managing check-in communications following a trigger event, may be implemented in the server 102 along with exemplary method 300 for managing check-in communications for travelers. The exemplary page of FIG. 8 can be used as part of the integrated implementation. For example, check-in communications for managing multiple different activities can be monitored through the page of FIG. 8. Tabs 808, 810, 812 are provided to allow an organizer 112 to quickly move between different layers of the page, for example, one layer showing automated voice system (e.g., IVR, etc.) check-in activities, one layer showing travel check-in activity (e.g., in accord with method 300, etc.), and one layer showing check-in activity in response to the trigger event (as illustrated in FIG. 8). A display header across the top of the page of FIG. 8, along with counts in the tabs 808, 810, 812, allows the organizer 112 to quickly view counts for pending (e.g., un-acknowledged, warning events, etc.), and completed (e.g., acknowledged) check-in communications for each of the activities (the automated voice system, travel check-ins, and trigger event check-ins), regardless of which layer of the page is shown. The display and tabs 808, 810, 812 quickly track (and count) completed, pending, and missing check-in communications in the persistent header, until the event is over. Further, the organizer, via the page of FIG. 8, for example, has the ability to check in participants 114, or send additional notifications to unresponsive participants 114, or even cancel a check-in communication individually. In some embodiments, additional layers may be provided to track acknowledgements that also include a “NOT OK” or “SICK” indication.

In some embodiments, communication devices 104 associated with participants 114 may include GPS devices. In at least one example, the communication device 104 determines its location, by the GPS device, and transmits its location to the server 102, either automatically, or in response to a request from the server 102. In this manner, the server 102 may locate the participants 114, via the communication devices 104, for any pending check-in communications, or when an acknowledgement includes a negative condition, for example, to direct help to the participants' location, etc.

In some embodiments, the communication device 104 associated with a participant 114 includes an application for managing check-in communications (e.g., in accordance with methods 300, 700, etc.) from the server 104. For example, the memory 204, and specifically, the non-transitory computer readable media, includes computer-executable instructions that when executed by the processor 202 cause the processor 202 to manage check-in communications for the participant 114. Using the application, which may communicate with server 102 via any available communication type (e.g., email, text message, etc.), the participant 114 may access and acknowledge check-in communications, and select response options (e.g., “OK” or “NOT OK”, etc.) through the application. In some aspects, the application may cause the mobile communication device to generate a tone, ring, vibrate, display an indicator, or otherwise visually and/or audibly indicate to the participant 114 that a check-in communication has been received, and needs attention. In addition, the application may include an “Emergency” button that a participant 114 can actuate, at any time, to prompt a response from the organizer. In some of these embodiments, the application may be used in connection with, or may be the same as, to manage travel check-in communications described for method 300, such that check-in communications for both the trigger event and any travel can be accessed via the application.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) assigning a risk value to a request for travel to at least one destination during a travel period, (b) creating a travel plan based on the assigned risk value, (c) sending a first check-in communication to a traveler at the first predetermined check-in time, (d) designating the first check-in communication completed, when the first check-in communication is acknowledged by the traveler within a time interval the first predetermined check-in time, (e) generating a warning event, when the first check-in communication is not acknowledged by the traveler within the time interval, after the first predetermined check-in time, (f) sending a reminder communication to the traveler within a reminder time interval of the first predetermined check-in time, (g) soliciting approval for the travel request from a traveler organizer, when the assigned risk value is above a predetermined threshold, and/or (h) receiving approval from the organizer of the travel for the travel request.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) receiving a notification request associated with a trigger event, the notification request indicative of multiple participants, (b) identifying the multiple participants, (c) sending a check-in communication, via a network interface, to each of the multiple participants, (d) for each check-in communication, generating, by a processor, a warning event when an acknowledgment for the check-in communication is received and the acknowledgement includes a negative condition, (e) designating, by the processor, the check-in communication completed when the acknowledgment for the check-in communication is received from the participant, (f) generating, by the processor, a warning event when an acknowledgment for the check-in communication is not received within a time interval after sending the check-in communication, (g) receiving, from an organizer, a selection of a facility indicative of the multiple participants and identifying the multiple participants, in a memory, based on the selected facility, and/or (h) sending a reminder communication, via the network interface, to the participant when no acknowledgment for the check-in communication is received within a time interval of sending the check-in communication.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “connected to,” or “coupled to” another element, it may be directly on, connected or coupled to the other element, or intervening elements may be present. In contrast, when an element is referred to as being “directly on,” “directly connected to,” or “directly coupled to” another element, there may be no intervening elements present. As used herein, the term “and/or” includes any and all combinations of one or more of the associated listed items.

Although the terms first, second, third, etc. may be used herein to describe various events that may be included in a travel plan, or other features. These terms may only be used to distinguish one element from another. Terms such as “first,” “second,” and other numerical terms when used herein do not imply a sequence or order unless clearly indicated by the context. Thus, for example, a first check-in communication described and claimed herein, could be termed a second check-in communication without departing from the teachings of the example embodiments.

What is claimed is:

1. A computer-implemented method for use in managing check-in communications, the method comprising:
receiving a notification request associated with a trigger event, the notification request indicative of multiple participants;
identifying the multiple participants;
sending a check-in communication, via a network interface, to each of the multiple participants;
for each check-in communication,
generating, by a processor, a warning event when an acknowledgment for the check-in communication is received and the acknowledgement includes a negative condition.

2. The method of claim 1, further comprising, for each check-in communication, designating, by the processor, the check-in communication completed when the acknowledgment for the check-in communication is received from the participant.

3. The method of claim 1, further comprising, for each check-in communication, generating, by the processor, a warning event when an acknowledgment for the check-in communication is not received within a time interval after sending the check-in communication.

4. The method of claim 3, further comprising causing the warning event to be displayed at one or more communication devices associated with an organizer of the check-in communication.

5. The method of claim 1, further comprising receiving, from an organizer, a selection of a facility indicative of the multiple participants; and
identifying the multiple participants, in a memory, based on the selected facility.

6. The method of claim 5, wherein at least one of the multiple participants is a traveler to the selected facility.

7. The method of claim 1, further comprising causing to be displayed, at a communication device associated with an organizer, a count of the check-in communications that are un-acknowledged.

8. The method of claim 1, wherein the notification request includes a notification message; and
wherein each of the check-in communications includes the notification message.

9. The method of claim 1, further comprising, for each check-in communication, sending a reminder communication, via the network interface, to the participant when no acknowledgment for the check-in communication is received within a time interval of sending the check-in communication.

10. A check-in management system for use by an organizer, the system comprising:
a memory configured to store a participant database; and
a processor coupled to the memory, the processor configured to identify multiple participants in the participant database associated with a trigger event,
the processor configured to send a check-in communication to each of the multiple identified participants and check for an acknowledgement from each of the multiple participants after the check-in communication is sent; and
the processor configured to set a warning event associated with at least one of the participants and notify the organizer, when the acknowledgement is received from the at least one of the participants and the acknowledgement indicates a negative condition.

11. The system of claim 10, wherein the processor is configured to display a notification request page to the organizer, at one or more communication devices, and receive a notification request indicating a facility in response to the notification request page; and
wherein the processor is further configured to search, in the participant database, for at least one participant associated with facility to identify the multiple participants.

12. The system of claim 11, wherein the processor is configured to determine a travel status of the at least one participant associated with the facility; and
wherein the processor is configured to exclude the at least one participant when the travel status indicates the at least one participant is traveling away from the facility.

13. The system of claim 10, wherein the processor is configured to set a warning event associated with at least one of the participants and notify the organizer, when the acknowledgement is not received from the at least one of the participants within a time interval after the check-in communication is sent.

14. The system of claim 13, wherein the processor is configured to identify the multiple participants in the participant database based on a location of the trigger event.

15. The system of claim 14, wherein the processor is further configured to cause to be displayed, at one or more communication devices, the warning event for the participant.

16. The system of claim 10, wherein each check-in communication includes a notification message having at least one instruction regarding the trigger event.

17. The system of claim 16, wherein the processor is further configured to cause to be displayed, at one or more communication devices, a first count of the check-in communications that are un-acknowledged and a second count of the check-in communications that are acknowledged.

18. One or more non-transitory computer readable media having computer-executable instructions embodied thereon for managing check-in communications, wherein when executed by a processor, the computer-executable instructions cause the processor to:
receive a notification request associated with a trigger event, the notification request indicating multiple participants associated with the trigger event;
for each of the multiple participants,
send a check-in communication to the participant; and
set a warning event when the check-in communication is acknowledged by the participant and the acknowledgment includes a negative indication.

19. The one or more non-transitory computer readable media of claim 18, wherein when executed by the processor, the computer-executable instructions further cause the processor to cause to be displayed, at one or more communication devices, a page indicating a count of the sent check-in communications that are un-acknowledged.

20. The one or more non-transitory computer readable media of claim 18, wherein at least one of the check-in communications includes a text message.

21. The one or more non-transitory computer readable media of claim 18, wherein the notification request includes at least one location associated with the multiple participants; and
wherein when executed by the processor, the computer-executable instructions further cause the processor to identify one or more of the multiple participants, in a participant database, based on the at least one location.
